(19) United States
(12) Patent Application Publication
(10) Pub. No.: US 2025/0043633 A1
(43) Pub. Date: Feb. 6, 2025

(54) Ladder Saddle Extension

(71) Applicants: Tanner Joseph Woldman, Calabasas, CA (US); Darin Samuel Woldman, Calabasas, CA (US)

(72) Inventors: Tanner Joseph Woldman, Calabasas, CA (US); Darin Samuel Woldman, Calabasas, CA (US)

(21) Appl. No.: 18/445,918

(22) Filed: Mar. 29, 2024

Related U.S. Application Data
(60) Provisional application No. 63/628,531, filed on Jul. 31, 2023.

(51) Int. Cl. E06C 7/14; B25H 3/04

(52) U.S. Cl. CPC E06C 7/14; B25H 3/04

(57) ABSTRACT

A sewn tool caddy that uses two hook and loop fasteners for placement in between the rungs of an extension ladder.

### FIELD

The Ladder Saddle Extension was developed as a means to safely store tools and fasteners while working from an extension ladder. The product is a sewn tool bag with a hook and loop system.

### BACKGROUND

The Ladder Saddle Extension offers a method of securing tools and fasteners while working off of an extension ladder. By using a hook and loop method of attachment, the Ladder Saddle Extension can be placed in between the rungs. On the back side of the panel are two hook and loop fasteners that wrap around an extension ladder rung. This system of attachment is innovative because it allows the user to work on multiple different levels of the ladder and not defined to only the top section. The tool bag can be placed at any height on the extension ladder because the hook and loop system is not limited to only one area. The Ladder Saddle Extension eliminates unnecessary trips up and down ladders by allowing the tools to be stored at the height of work on the ladder.

### SUMMARY

The Ladder Saddle Extension uses hook and loop fasteners to allow easy placement on the ladder. Once attached to the rungs the tool bag acts as a mobile work station while working from the extension ladder. The tool bag is designed to hold various common construction hand tools and fasteners. The Ladder Saddle Extension is innovative because the hook and loop fasteners allow for a wide variety of locations that the tool bag can be placed on the ladder. The tool caddy is a sewn product made from ballistic nylon 1680 denier, but can be made from other materials.

### BRIEF DESCRIPTION OF THE DRAWINGS

All seams are numbered and shown with a circle on each drawing.

FIG. 1 a flat view of the front primary panel with seams 1, 2, 3, 4.

FIG. 2 a flat view of the back primary panel with seams 5, 6, 7, 8.

FIG. 3 a flat view of the handle with seams 25 and 26.

FIG. 4 a flat view of the hand-held tool pocket with seams 17, 18, 19, 20.

FIG. 5 a flat view of the top reinforcement band for hand-held tool pocket.

FIG. 6 a flat view of the bottom reinforcement band for the hand-held tool pocket.

FIG. 7 a flat view of the top reinforcement band for the holster.

FIG. 8 a flat view of the bottom reinforcement band for the holster.

FIG. 9 a view of the hammer loop with seams 27 and 28

FIG. 10 a view of the secondary hammer loop with seams 29 and 30

FIG. 11 a flat view of the deep pocket with fold lines shown as dotted lines. Shown are seams 9, 10, 11, 12, 13, 14, 15, 16.

FIG. 12 a flat view of the top reinforcement band for the deep pocket.

FIG. 13 a flat view of the holster panel with seams 21, 22, 23, 24.

FIG. 14 a flat view of the hook strip.

FIG. 15 a flat view of the loop strip.

FIG. 16 a flat view of loop strip.

FIG. 17 a flat view of the hook strip.

FIG. 18 a flat view of the top reinforcement band for the main panels.

FIG. 19 a flat view of the reinforcement band for the side of the main panel.

FIG. 20 a flat view of the reinforcement band for the bottom of the main panel

FIG. 21 a flat view of the reinforcement band for the side of the main panel.

FIG. 22 a completed view of the front panel showing FIGS. 1, 3, 4, 5, 6, 7, 8, 9, 10, 11, 12, 13, 18, 19, 20, 21. Shown are the hand held tool pocket, the holster, the two hammer loops, and the deep pocket. Also shown is the handle and reinforcement side bands.

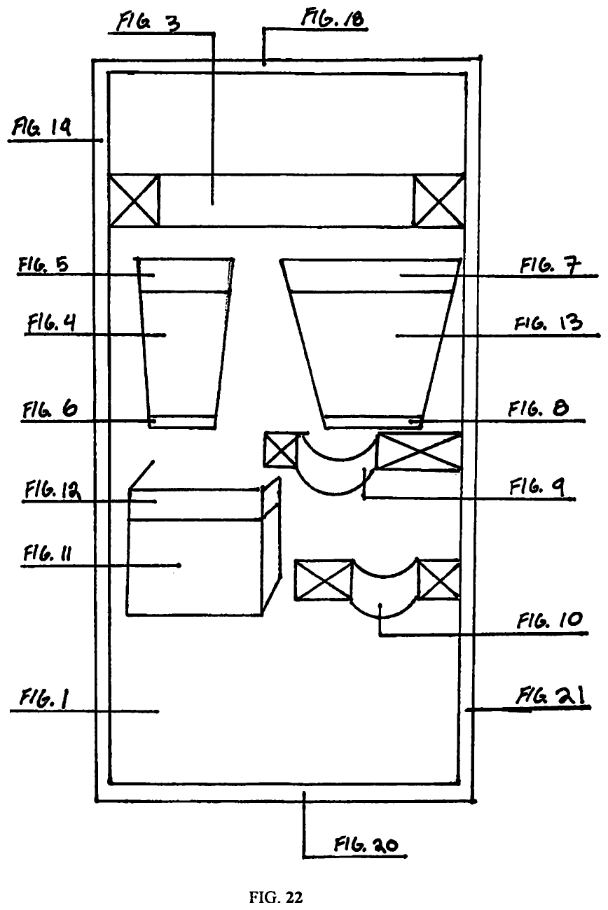

FIG. 23 a completed view of the back panel showing the positions of the hook and loop fasteners and reinforcement bands.

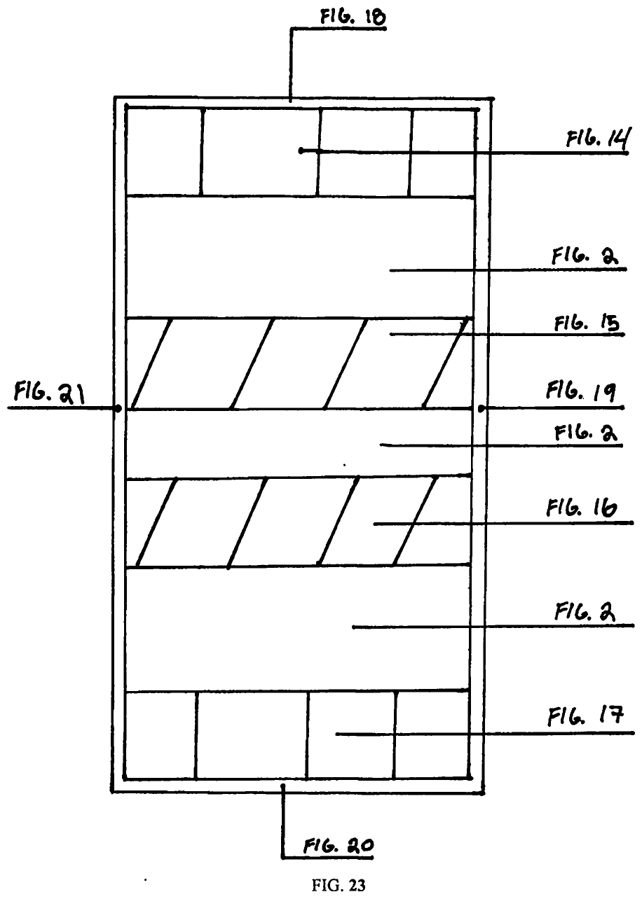

### DETAILED DESCRIPTION

The Ladder Saddle Extension allows a safe and secure way to store and utilize hand tools while working from an extension ladder. The Ladder Saddle Extension is a sewn tool holder that secures tools and fits taut between the rungs of an extension ladder. Using a hook and loop system the tool bag wraps around the rungs and remains secure. The material of choice is a 1680 denier ballistic nylon material, but is not limited to this. The Ladder Saddle Extension allows for users to safely and efficiently complete work while at elevated heights. The hook and loop system is unique because it allows the user to position the tool holder at any height along the length of the extension ladder.

The front panel is composed of one deep pocket, a hand-held tool pocket, two hammer loops, and a main holster. The back panel is made up of two hook and loop strips. All exposed seams are covered with reinforcement bands to protect from wear and tear.

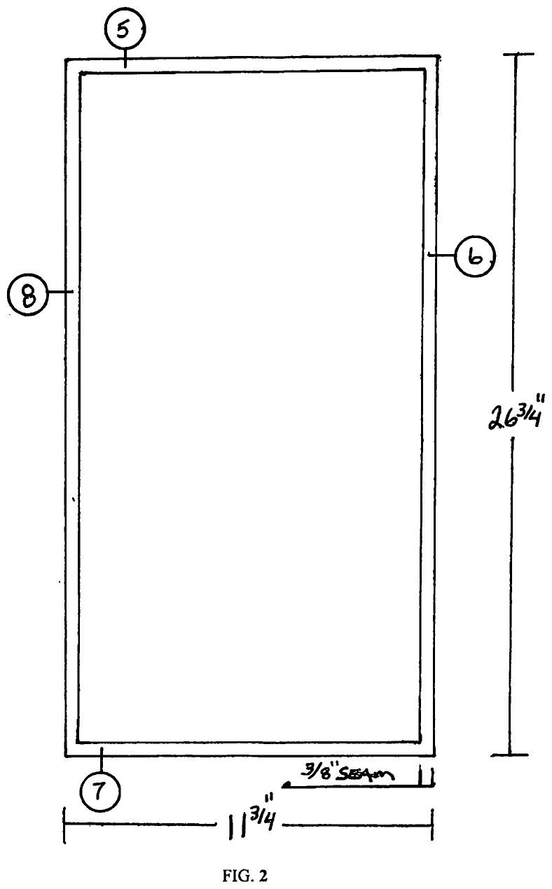

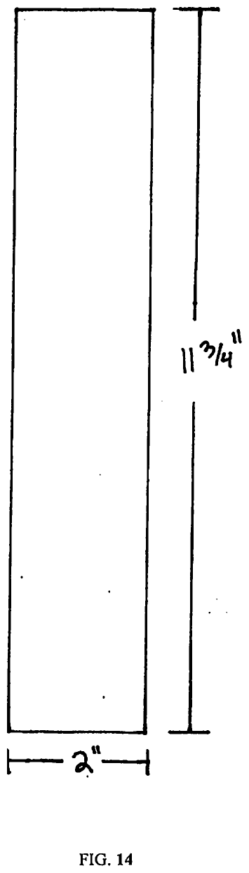

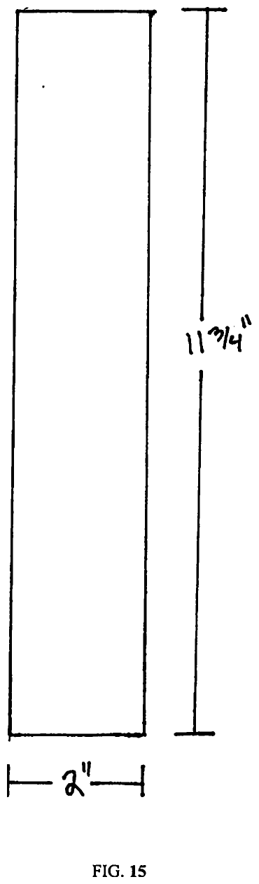

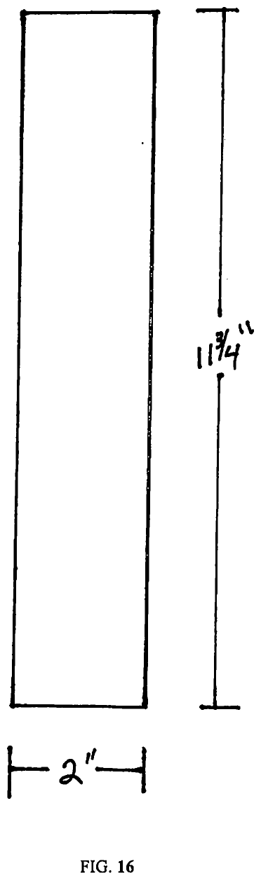

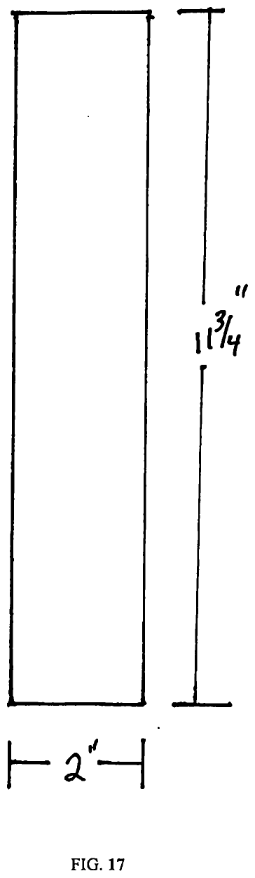

The building process is as followed, but not limited to this order of construction. Start by cutting out each shape by consulting the drawings for specific sizes and material types. With FIG. 2 mark out seams 5, 6, 7, 8. Each seam is ⅜″ inch wide. Next place FIG. 14 below seam 5 and sew all around the perimeter of FIG. 14. Below this measure down 7″ inches from the bottom of FIG. 14. At this point place FIG. 15 and sew all around the perimeter. At the bottom of FIG. 15 measure down 4″ inches and at this point place FIG. 16. Sew all around the perimeter of FIG. 16. From the bottom of FIG. 16 measure down 7″ inches and place FIG. 17. Sew around the entire perimeter of FIG. 17. This creates the back panel with two pairs of hook and loop fasteners.

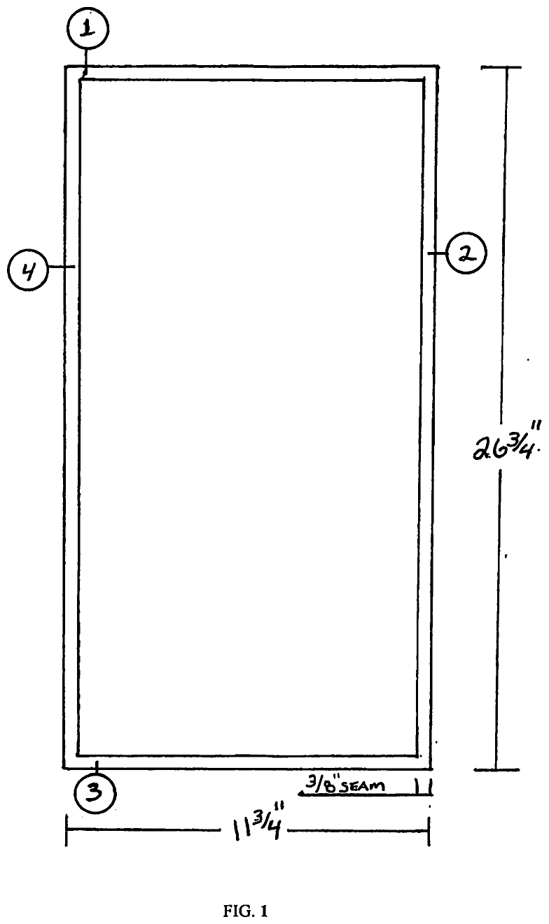

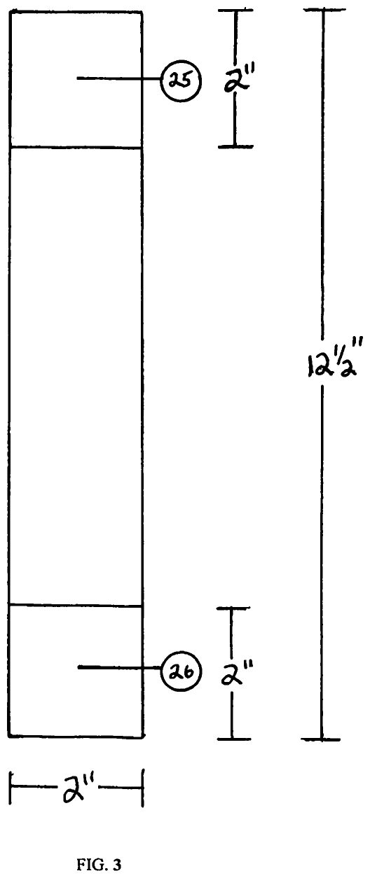

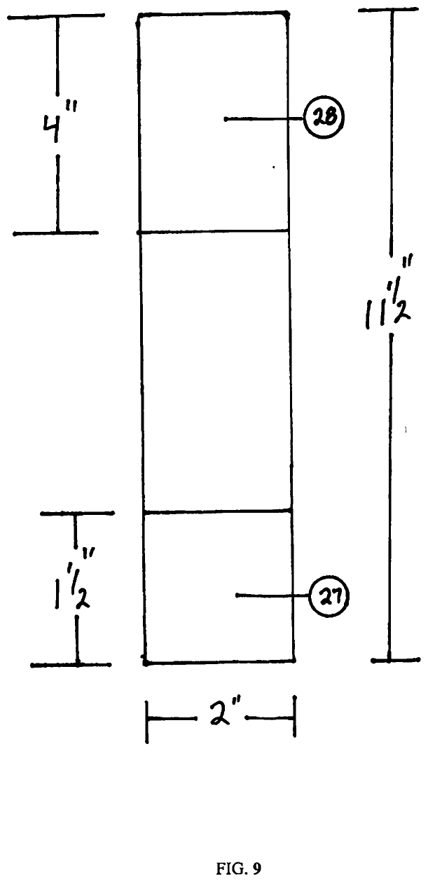

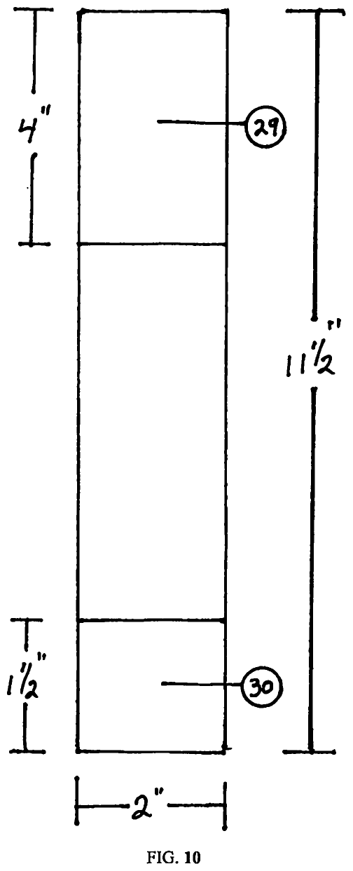

Next take FIG. 1 and mark out seams 1, 2, 3, 4. Each seam is a ⅜″ inch wide. From the top of seam 1 measure down 7″ inches and strike a horizontal line. Above this line place FIG. 3 and sew seams 25 and 26 with a heavy duty X stitch. This step creates the handle. From the bottom of FIG. 1 measure up 7″ inches and strike a line. Above this line place FIG. 10. Place seam 30 on seam 2 and sew with a heavy duty X stitch. Place seam 29 towards the center of the panel and sew with a heavy duty X stitch. Next take FIG. 9 and place it 2 and a ½″ inches above FIG. 10. Seam 28 attaches to seam 2 with a heavy duty X stitch. Seam 27 placed towards the center of the panel. This creates two hammer loops that are offset from one another.

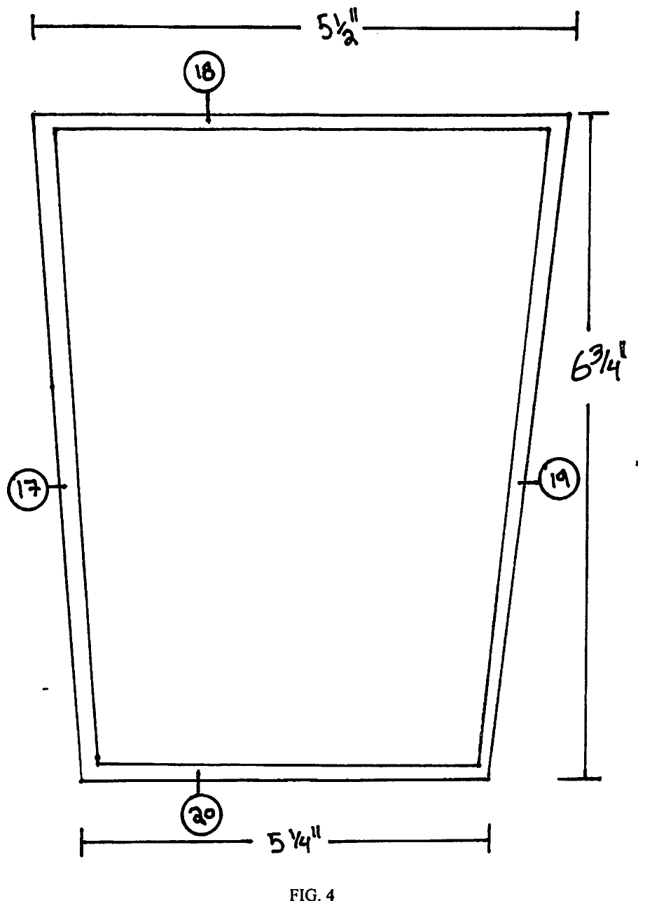

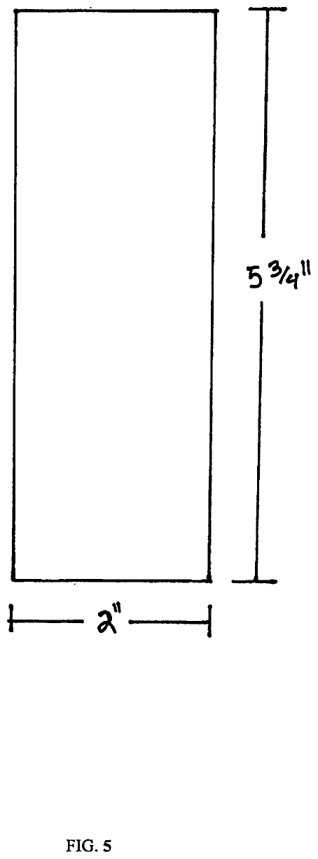

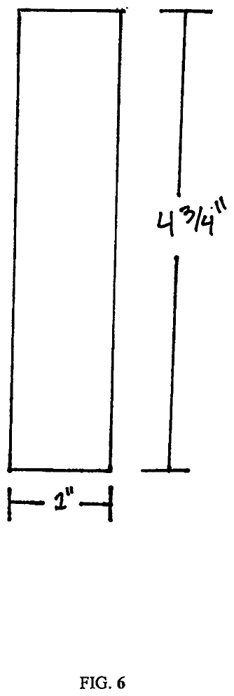

Take FIG. 4 and fold over seam 18 and seam 20. Take FIG. 5 and place opposite of folded seam 18 and sew around the entire perimeter of FIG. 5 with a heavy a duty stitch. Opposite the folded seam 20 place FIG. 6 and sew a heavy duty stitch around the entire perimeter of FIG. 6. This creates the reinforced hand-held tool pocket. Place the modified FIG. 4 seam 17 an inch away from the outside of seam 4 just below FIG. 3. Tack sew the top corner of seam 17 and pinch the modified FIG. 4 so that the top of seam 19 ends at 5 inches from seam 17 start point. Next tack the bottom of seam 17 an inch and a ½″ from the outside of seam 4. Tack sew the bottom of seam 19 so that it ends 4 and a ½″ inches from the outside of seam 4. Sew the length of seam 17 and seam 19 with a heavy duty stitch. This creates a reinforced hand-held tool pocket.

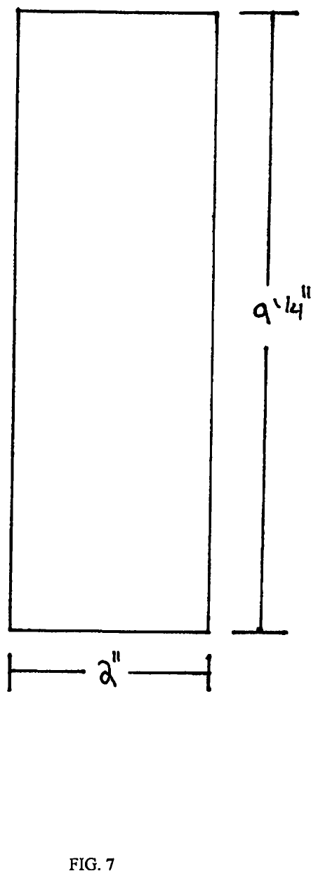

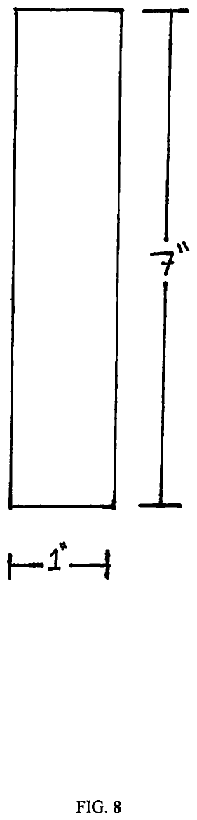

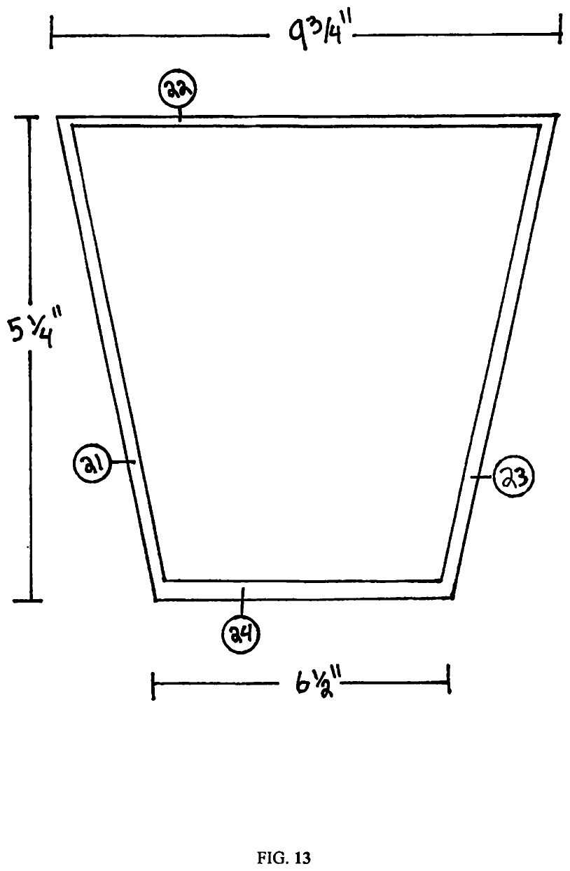

Take FIG. 13 seams 22 and 24 and fold them. Place FIG. 7 opposite folded seam 22. Sew the perimeter with a heavy duty stitch. Take FIG. 8 and place opposite folded seam 24. Sew the perimeter with a heavy duty stitch. This creates the reinforced holster. Place the reinforced holster adjacent to the hand-held tool pocket. Tack sew the top of seam 21 next to top of FIG. 4 and below the strike line. Pinch the holster so that it ends 1″ inch away from the outside of seam 2. Tack sew the top of seam 23. Tack sew the bottom of seam 21 and seam 23 to maintain the shape of holster. Sew the lengths of seams 21 and 23 with a heavy duty stitch. This creates a reinforced holster.

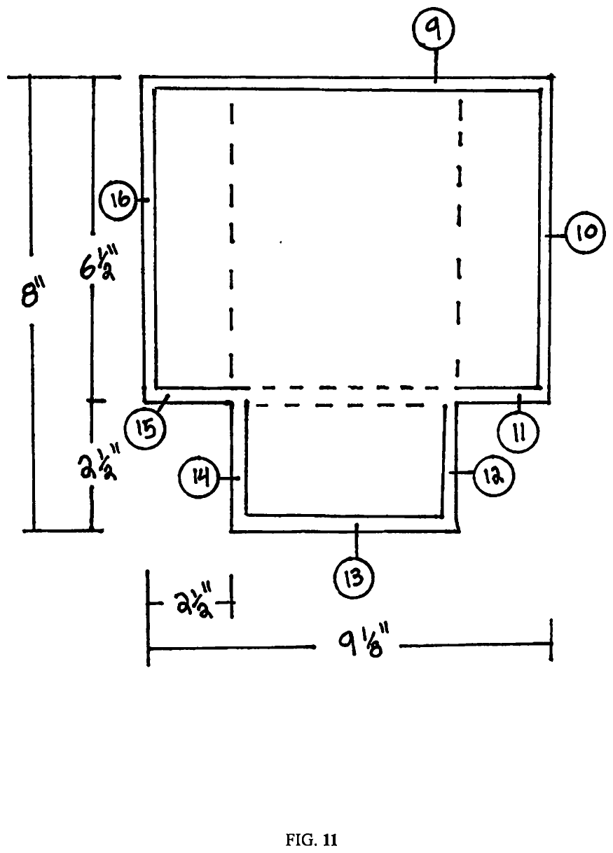

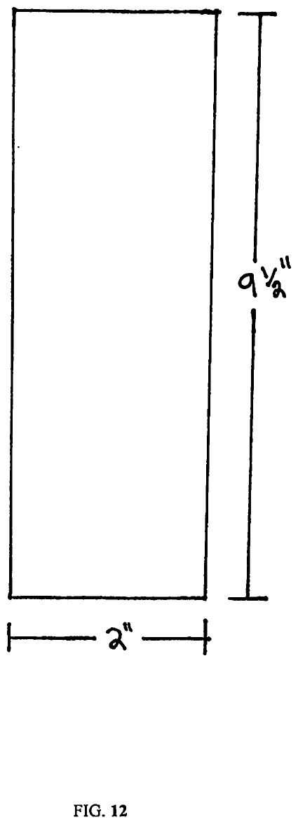

Take FIG. 11 and fold over seam 9. Take FIG. 12 and place opposite of the folded over seam 9 and sew the entire perimeter with a heavy duty stitch. Take the piece laying flat with FIG. 12 facing down and fold up seam 15 and move that flap in along the drawn fold line. Sew seam 15 to seam 14 with seam 15 being on top. Leave seam 16 exposed for later attachment. Take seam 11 and fold it up and move that flap in along the drawn fold line and attach to seam 12. Seam 11 is on top of seam 12. Seam 10 is exposed for attachment to panel. Seam 13 is left folded down for attachment to panel. Take this modified FIG. 11 and place seam 10 on the inside of seam 4 just below the hand-held tool pocket. Sew the entire length of seam 10. Along the bottom sew the exposed flap of seam 13 along the entire length. Next sew the entire length of seam 16. This process creates a reinforced deep pocket.

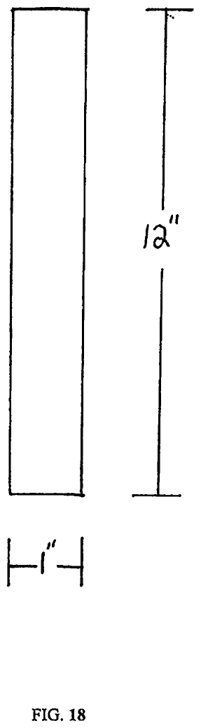

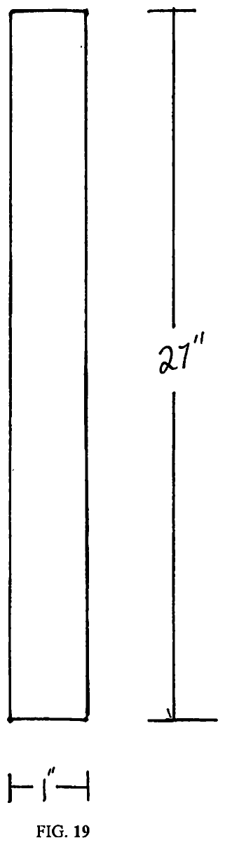

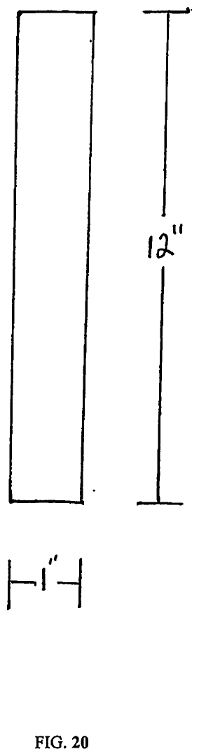

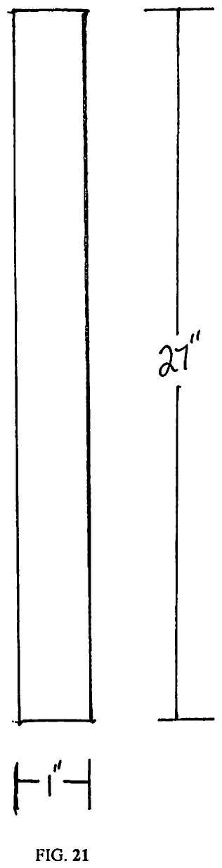

Take the completed main panel and attach it to the completed back panel. Flip the panels opposite so that the pockets and hook and loop fasteners are all exposed. Sew seam 1 to seam 5. Sew seam 4 to seam 6. Sew seam 3 to seam 7. Sew seam 2 to seam 8. Use a heavy duty stitch throughout each seam. Next attach the reinforcement bands. Fold each reinforcement band so they split the covering seam evenly. FIG. 18 attaches to seam 1 and 5. FIG. 19 attaches to seam 4 and seam 6. FIG. 20 attaches to seams 3 and 7. FIG. 21 attaches to seams 4 and 8. Sew the entire perimeter with a heavy duty stitch. This creates the completed Ladder Saddle Extension.

1. A sewn double sided panel comprised of two hook and loop systems; one hook and loop on the bottom of the backside; the other hook and loop is on the top of the backside.
1) As related to claim 1, the face of the panel is composed of two hammer loops, a holster, a deep pocket, and a hand-held tool pocket.
2) As related to claim 1, all pocket seams are to be reinforced with heavy duty reinforcement bands.
3) As related to claim 1, a handle is placed at the center of the top of the primary panel.
